(19) United States
(12) Patent Application Publication
(10) Pub. No.: US 2026/0013416 A1
(43) Pub. Date: Jan. 15, 2026

(54) PLANTER ROW UNIT HEALTH MONITORING SOLUTION

(71) Applicant: Deere & Company, Moline, IL (US)

(72) Inventor: Lance R. Sherlock, Asbury, IA (US)

(21) Appl. No.: 18/767,446

(22) Filed: Jul. 9, 2024

(51) Int. Cl. A01C 5/06; A01C 7/10; A01C 7/20

(52) U.S. Cl. CPC A01C 5/064; A01C 7/102; A01C 7/201

(57) ABSTRACT

A planter row unit includes a frame and a cutting wheel disc supported directly or indirectly from the frame for cutting a furrow in a ground surface. A seed delivery mechanism is supported directly or indirectly from the frame to deposit seeds into the furrow. A vibration sensor is supported directly or indirectly from the frame. A controller is configured to receive signals from the vibration sensor and to monitor a vibration profile of the planter row unit over time.

### BACKGROUND OF THE DISCLOSURE

### Field of the Disclosure

The present application relates to systems for monitoring the operation of an agricultural implement including a cutting disc which is subject to wear.

### Description of the Prior Art

Modern large-scale planters may have dozens of individually controlled planter row units which control the seed delivery into the planting furrows. A farmer must be able to tell if each planter row unit is operating correctly to maximize the resulting crop. The work of planting creates wear on the ground engaging parts of the planter row unit. For example, the cutting wheel discs wear down over time. The farmer must make regular measurements of disc wear to know whether the disc wear is too great to continue use of the disc. There are other failure points on the planter row units due to usage and ground engagement. A planter row unit may hit a rock and be bent thus causing inefficient operation of the planter row unit. Wheel bearings or press fits on the various wheels of the planter row unit may wear out. Many of these conditions are difficult for the farmer to detect, even during a typical walk-around inspection.

There is a need for improved systems to aid the farmer in monitoring the operation of the planter row units, and particularly to detect the various problems noted above.

### SUMMARY OF THE DISCLOSURE

In one embodiment a planter row unit includes a frame, a cutting wheel disc supported from the frame for cutting a furrow in a ground surface, a seed delivery mechanism supported from the frame to deposit seeds into the furrow, a vibration sensor supported from the frame and a controller configured to receive signals from the vibration sensor and to monitor a vibration profile of the planter row unit over time.

Some aspects of the present disclosure are applicable to other types of agricultural implements including a cutting disc subject to wear. In another embodiment an agricultural implement includes a frame and a disc supported from the frame for cutting a furrow in a ground surface, the disc including a ground engagement surface configured to engage the ground surface to cut the furrow and a wear indicator configured to change a shape of the ground engagement surface as the disc wears.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a perspective view showing an agricultural implement in the form of a planter row unit with a furrow shaper (in phantom).

FIG. 2 is a side elevational view, with portions broken away, showing the planter row unit.

FIG. 3 is an exploded perspective view showing the furrow shaper, a guard of a frame of the row unit to which the furrow shaper is to be mounted, and a shank of the frame to which the guard is to be mounted.

FIG. 4 is a plan view of a tractor pulling a planter including a plurality of the planter row units of FIGS. 1-3.

FIGS. 5A and 5B are schematic side elevation views of an unworn and a worn cutting wheel disc, respectively, including a wear indicator. The wear indicator includes eight holes arranged in a pattern radially inset from the circumference of the disc.

FIG. 6A is a schematic side elevation view of an unworn cutting disc having a wear indicator including twelve holes arranged in a pattern radially inset from the circumference of the disc.

FIG. 6B is a schematic side elevation view of the disc of FIG. 6A in a partially worn condition.

FIG. 6C is a schematic side elevation view of the disc of FIGS. 6A and 6B in a completely worn condition.

FIGS. 7A-7F are graphic displays of a plurality of vibration profiles of the planter row unit.

FIG. 8A is a schematic illustration of one embodiment a planter row unit control system including a controller and various inputs and outputs.

FIG. 8B is a schematic illustration of a control system including multiple planter row unit controllers plus a master controller.

FIG. 8C is a schematic illustration of a control system including vibration sensors on each planter row unit, with a central controller.

### DETAILED DESCRIPTION

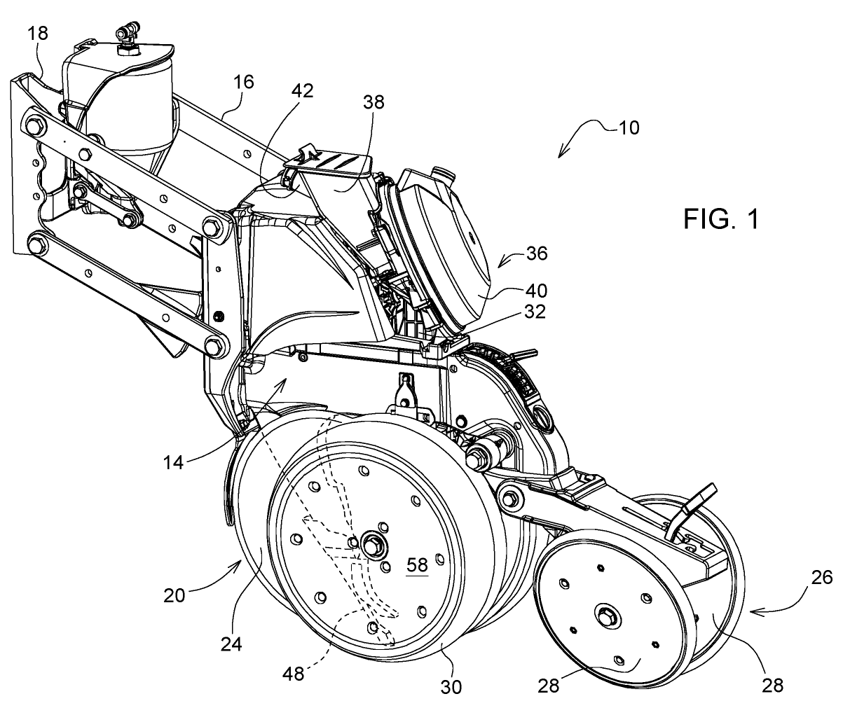

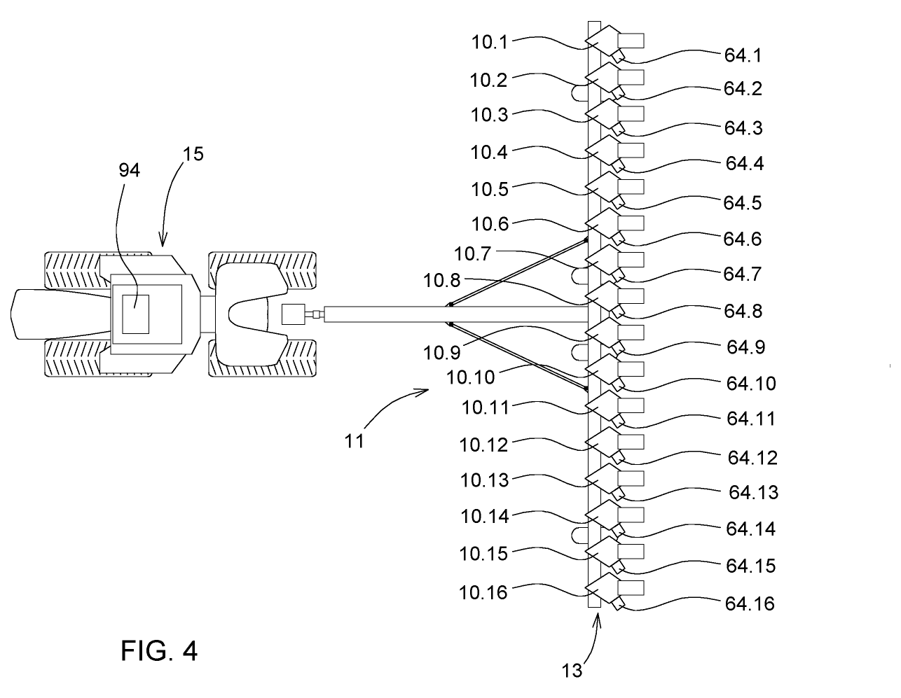

Referring to FIGS. 1, 2 and 4, an agricultural implement in the form of a planter row unit 10 may be used in a planter 11 having a number of such row units mounted to a toolbar 13 of the planter 11. Each row unit 10 is configured to plant seeds 21 in a furrow 17 in the ground or ground surface 19, as the planter 11 is moved in a planting direction of travel 12 through a field by, for example, a tractor 15. In the embodiment illustrated in FIG. 4 there are sixteen planter row units identified as 10.1-10.16. There may be fewer or greater than sixteen planter row units. Indeed planters are known to have as many as seventy-two planter row units 10.

The row unit 10 comprises a frame 14 and a four-bar linkage 16 that mounts the frame 14 to the toolbar. The linkage 16 comprises a bracket 18 bolted to the toolbar 13.

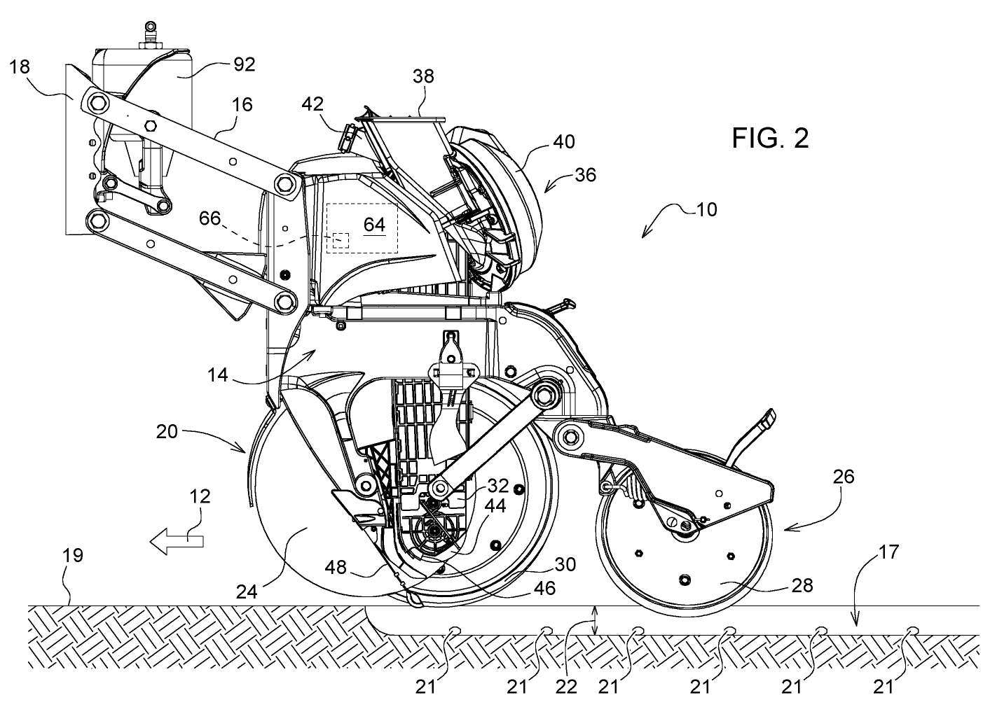

The row unit 10 comprises a furrow opener 20 mounted to the frame 14 to open a furrow in the ground. The furrow opener 20 may comprise two cutting wheel discs 24, one of which is shown, for example, in FIG. 2, positioned relative to one another to open the furrow 17.

The row unit 10 comprises a furrow closer 26 mounted to the frame 14 to close the furrow. The furrow closer 26 is positioned rearwardly of the furrow opener 20 relative to the planting direction of travel 12 of the row unit 10. The furrow closer 26 may comprise two closing wheels 28 positioned relative to one another to close the furrow 17.

The row unit 10 comprises two gauge wheels 30 mounted to and positioned on opposite sides of the frame 14. The gauge wheels 30 cooperate to establish the depth of the furrow opener 20 and correspondingly the depth of the furrow 17. The gauge wheels 30 are vertically movable relative to the frame 14 to a stop which sets the furrow depth 22.

The row unit 10 comprises a seed delivery mechanism 32 mounted to the frame 14 to deposit seed into the furrow 17. The seed delivery mechanism 32 is positioned between the furrow opener 20 and the furrow closer 26 relative to the planting direction of travel 12 of the row unit 10

The seed delivery mechanism 32 is included in a seed supply system 36 of the row unit 10. Illustratively, the seed supply system 36 comprises a hopper 38 and a vacuum seed meter 40. The hopper 38 is configured to receive seed from a source (not shown) via a hopper inlet 42. The seed meter 40 is configured to receive seed from the hopper 38, and singulate the seed on respective apertures (not shown) of the meter 40 to which a vacuum pressure is applied.

Illustratively, the seed delivery mechanism 32 is configured as a brush-belt cartridge. The brush-belt cartridge comprises a brush belt 44 (shown diagrammatically) circulating to pick up seed one-by-one from the seed meter 40 and to deliver the seed to a seed outlet 46 of the mechanism 32 where the brush belt 44 releases the seed, which is under centrifugal force as the brush belt 44 makes a turn near the bottom of its cycle. The mechanism 32 is configured to deposit each seed 21 into the furrow 17. Other seed delivery mechanisms may be used to deposit seed into the furrow 17, such as, for example, a seed tube.

The row unit 10 comprises a furrow shaper 48 mounted to the frame 14. The furrow shaper 48 is positioned relative to the furrow opener 20 and the seed delivery mechanism 32 to shape the furrow 17, opened by the furrow opener 20, ahead of seed deposited into the furrow by the seed delivery mechanism 32 relative to the planting direction of travel 12 of the planter row unit 10. Illustratively, the furrow shaper 48 is positioned at least in part between the furrow opener 20 and the seed delivery mechanism 32 relative to the planting direction of travel 12.

When the furrow opener 20 opens the furrow 17, it may form the furrow 17 with a W-shaped cross-section lateral to the planting direction of travel 12, in which case the seed may fall to one side or the other of the furrow in a somewhat uncontrolled manner. The furrow shaper 48 is configured to shape the bottom of the furrow 17 such that the bottom of the furrow 17 has a generally V-shaped lateral cross-section, so as to position the seed in the vertex of the V shape. Alternatively, the furrow shaper 48 may be configured to shape the bottom of the furrow so as to have a U-shaped lateral cross-section, or other suitable shape.

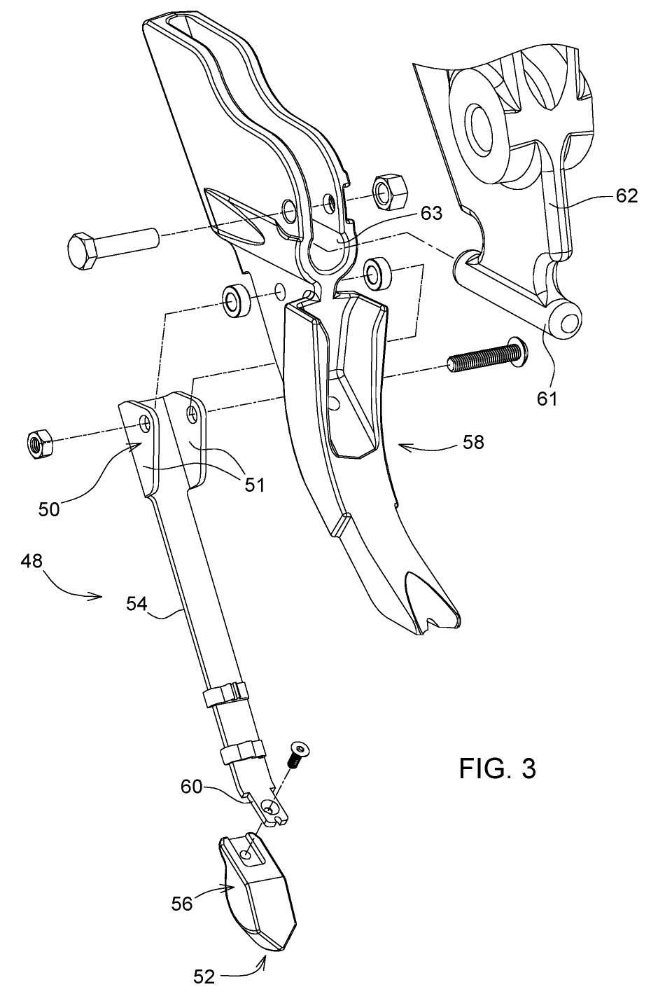

Referring to FIG. 3, the furrow shaper 48 comprises a proximal end 50 and a distal end 52. The proximal end 50 is mounted to the frame 14. The distal end 52 is configured to form the furrow, for example, with the V shape.

The furrow shaper 48 comprises a leg 54 and a foot 56 profiled to shape the furrow. The leg 54 provides the proximal end 50 of the furrow shaper 48, which is also the proximal end of the leg 54. The proximal end 50 comprises a pair of flanges 51 fixed to a guard 58 (e.g., bolted with a bolt, a nut, a washer positioned on one side of the guard 58, and another washer positioned on the opposite side of the guard 58). The leg 54 projects downwardly to position the foot 56 in the furrow.

The foot 56 provides the distal end 52 of the furrow shaper 48, and is mounted to a distal end 60 of the leg 54 (e.g., with a screw). The foot 56 is configured to shape the furrow, for example, with the V shape.

The guard 58 is positioned between the furrow shaper 48 and the seed delivery mechanism 32 to shield the seed delivery mechanism 32 from dirt and debris during planting. The guard 58 is a wearable item (made, for example, of metal). It is fixed (e.g., bolted) to a shank 62 of the frame 14 so as to be removable therefrom and replaced upon reaching the end of its service life, in which case the furrow shaper 48 may be removed from the worn guard and mounted to a fresh guard. The bottom of the shank 62 comprises a post 61 received in a post-receiving portion 63 of the guard 58.

The furrow shaper 48 is spring biased downwardly to press against the bottom of the furrow. As such, the furrow shaper 48 is able to maintain contact with the bottom of the furrow despite some variation in the level of the ground or bottom of the furrow.

The leg 50 is spring biased downwardly to press the foot 56 against the bottom of the furrow. The leg 50 may be a flat spring to provide this spring bias.

Each planter row unit 10 may include a planter row unit controller 64 configured to control the operation of the seed delivery mechanism 32 and the other components of the planter row unit 10. The planter row unit controller 64 may control parameters such as furrow depth, down pressure, seed delivery rate, and the like. As schematically shown in FIG. 2 the planter row unit controller 64 may be supported directly or indirectly from the frame 14.

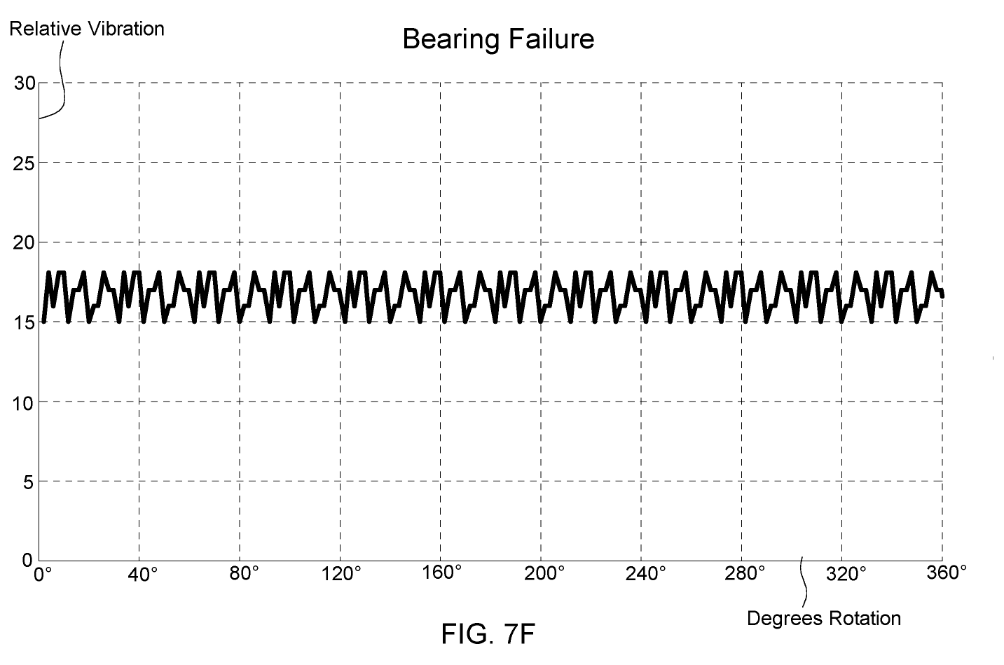

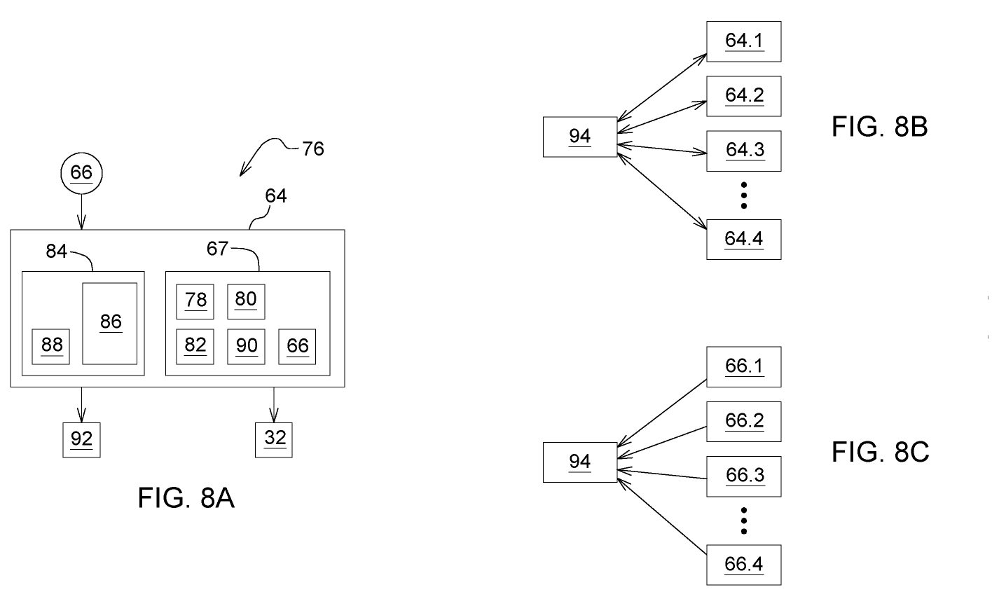

The planter row unit 10 includes a vibration sensor 66. The vibration sensor 66 may for example be in the form of an Inertial Measurement Unit (IMU) or it may be an accelerometer. In one embodiment as schematically represented in FIG. 8 the vibration sensor 66 may take the form of an electrical component mounted on a circuit board 67 of the planter row unit controller 64. In another embodiment, the vibration sensor 66 may be separately mounted directly or indirectly on the frame 14, and electronically communicated with the planter row unit controller 64.

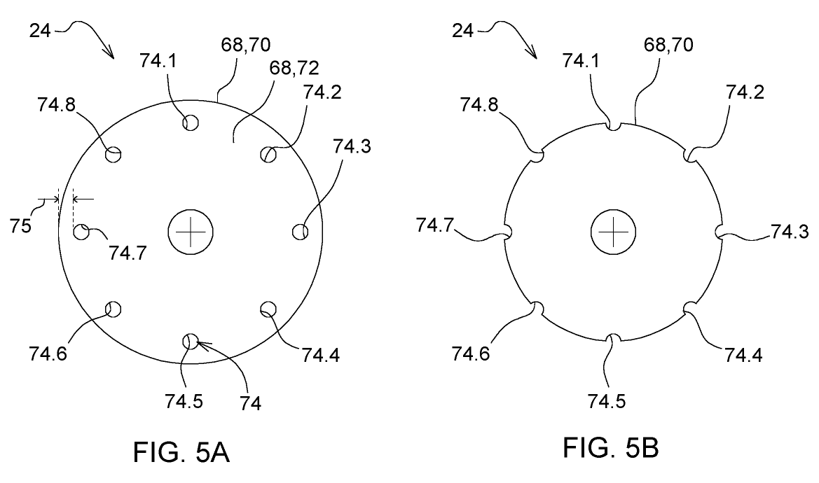

As schematically shown in FIGS. 5A and 5B, the cutting wheel discs 24 may include a ground engagement surface 68 configured to engage the ground 19 to form the furrow 17 in the ground 19. The ground engagement surface 68 may for example include a circumferential periphery 70 of the cutting wheel disc 24 along with a radially outer portion 72 of the cutting wheel disc 24 adjacent to the circumferential periphery 70.

The cutting wheel disc further may further include a wear indicator 74 configured to change a shape of the ground engagement surface 68 as the cutting wheel disc 24 wears. In the embodiment shown the wear indicator 74 includes one or more holes 74.1-74.8 formed in the cutting wheel disc 24 and arranged such that as the ground engagement surface 68 wears the ground engagement surface 68 merges with the one or more holes 74.1-74.8 thereby creating an interruption in the ground engagement surface 68. Particularly, as seen in FIG. 5B the circumferential periphery 70 has worn down until it merges with the holes 74.1-74.8 thus creating a worn circumferential periphery 70 which is interrupted by the remaining portions of the holes 74.1-74.8 thus creating a jagged cutting edge on the worn cutting wheel disc 24.

In one example as schematically shown in FIGS. 5A-5B of a cutting wheel disc 24 having an initial unworn diameter in a range of from about ten to about twelve inches, the wear indicator 74 may take the form of a circular pattern of eight equally spaced holes 74.1-74.8 of diameter in a range of from about 0.5 inch to about 1.0 inch, preferably in a range of from about 0.7 inch to about 0.8 inch. The pattern of holes may be concentric with the periphery 70. The radially outermost portions of the holes may be spaced from the periphery 70 of the unworn disc by a spacing or distance 75 in a range of from about 0.25 inch to about 3.0 inch, or in a range of from about 0.7 inch to about 1.3 inch, or in a range of from about 0.9 inch to about 1.1 inch.

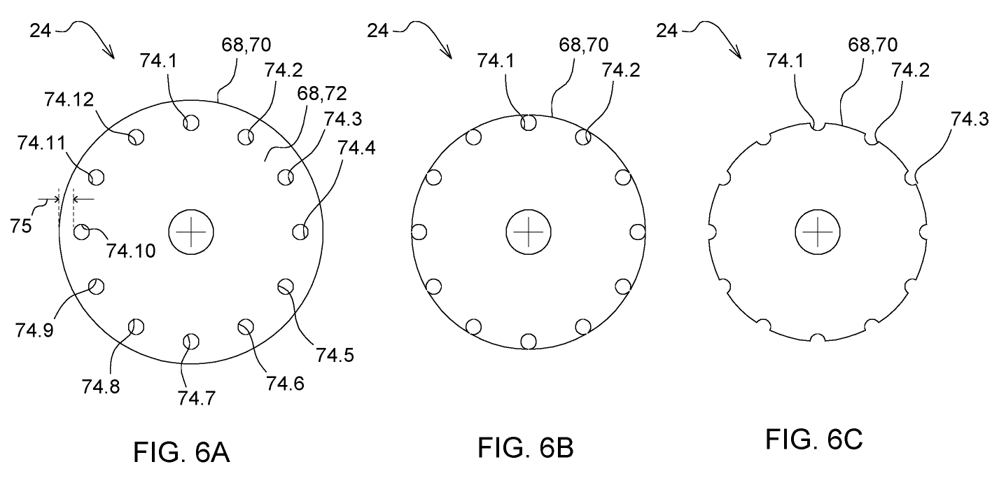

In another example as schematically shown in FIGS. 6A-6C of a cutting wheel disc 24 having an initial unworn diameter in a range of from about ten to about twelve inches, the wear indicator 74 may take the form of a pattern of twelve equally spaced holes 74.1-74.12 of diameter in a range of from about 0.5 inch to about 1.0 inch, preferably in a range of from about 0.7 inch to about 0.8 inch. The radially outermost portions of the holes may be spaced from the periphery 70 of the unworn disc by a spacing or distance 75 in a range of from about 0.25 inch to about 3.0 inch, or in a range of from about 0.7 inch to about 1.3 inch, or in a range of from about 0.9 inch to about 1.1 inch.

The holes may be circular as shown, or they may be of other shapes. For example, the holes may be elongated in the circumferential direction. The holes may be rectangular, or triangular, or any other shape. The holes may be formed by drilling or punching or any other suitable process.

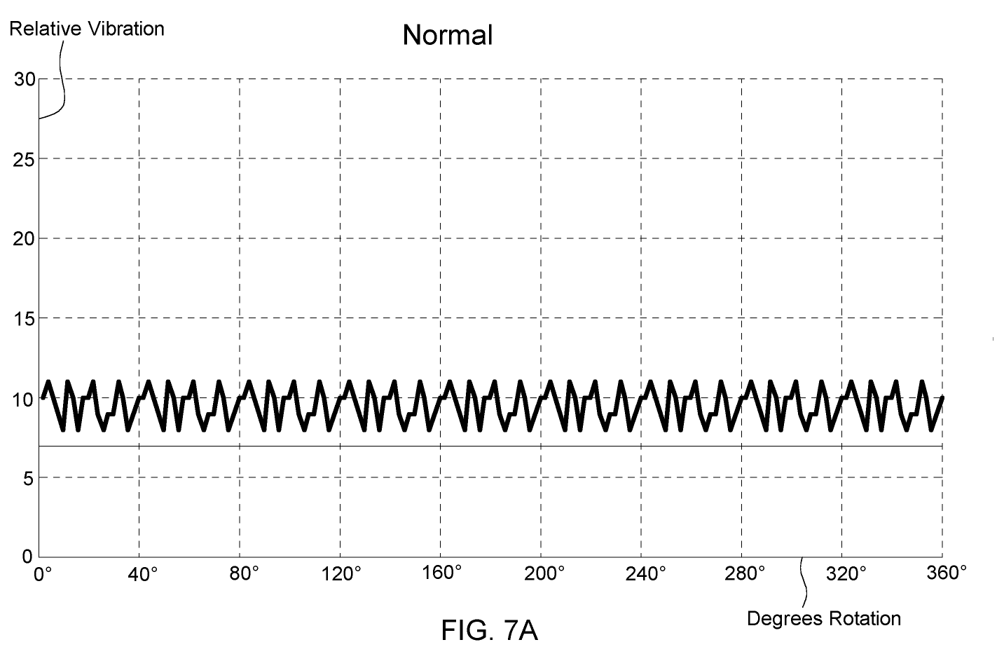

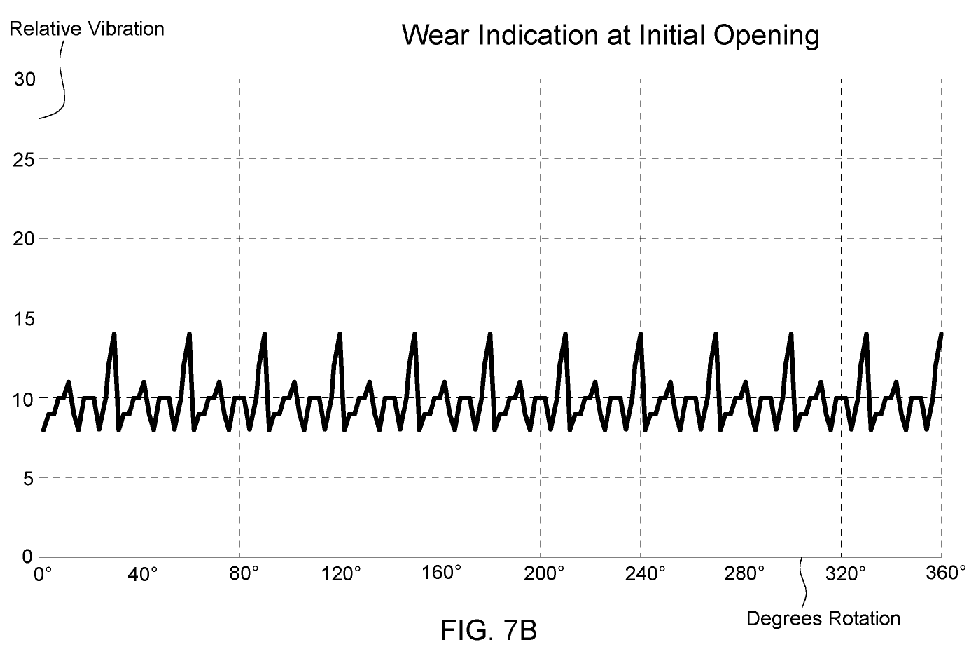

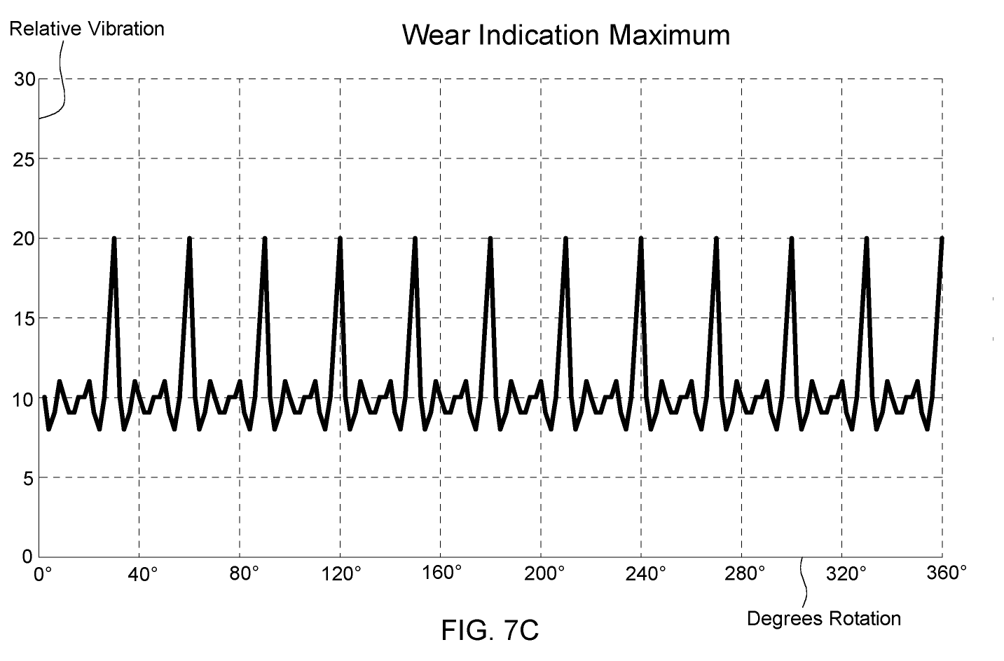

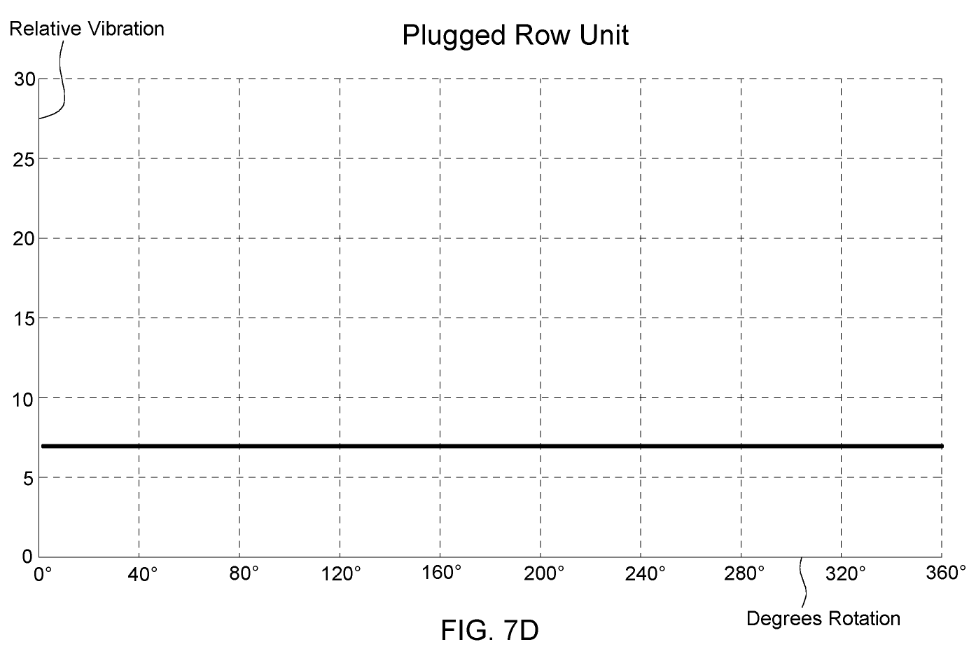

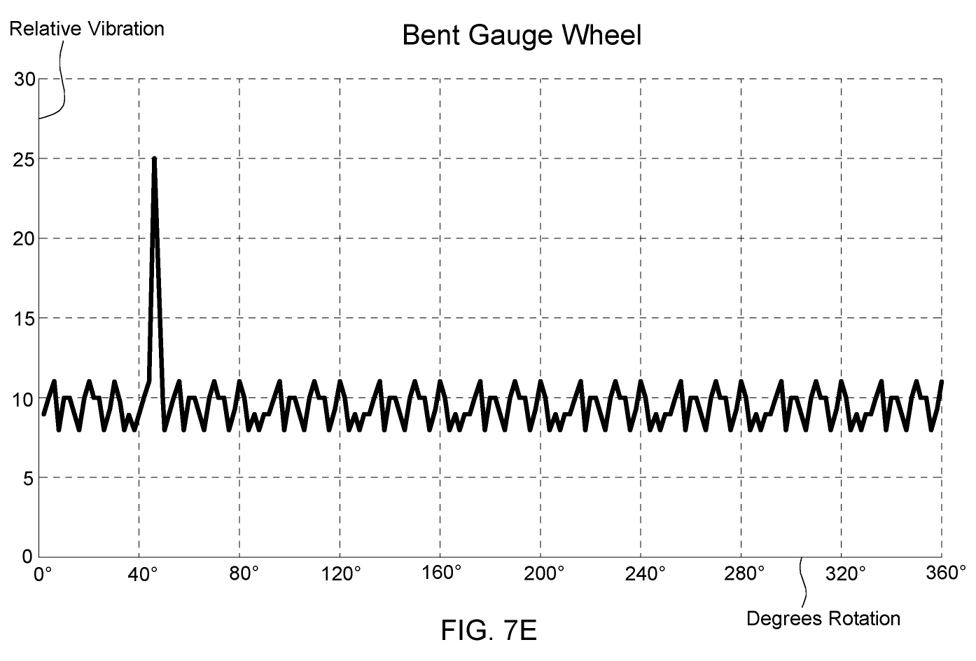

It will be appreciated that the vibrational characteristics of the planter row unit 10 will change as the shape of the ground engagement surface 68 which cuts the furrow 17 in the ground 19 changes. As is further explained below with reference to the example vibration profiles of FIGS. 7A-7F, the vibration sensor 66 and the planter row unit controller 64 can detect and identify these changes so as to monitor and identify a wear state of the cutting wheel discs 24.

It will be appreciated that certain aspects of the present disclosure are applicable to other types of agricultural implements including cutting discs. For example, the agricultural implement may be a disk system including a frame carrying a plurality of tillage discs configured for tillage or plowing of a field. Such machines are sometimes referred to as disks, or as field cultivators, or as vertical tillage machines.

### Planter Row Unit Controller:

As schematically illustrated in FIG. 8A, each planter row unit 10 may include a control system 76 including the planter row unit controller 64. The planter row unit controller 64 is configured to receive input signals from the various sensors, such as the vibration sensor 66. The signals transmitted from the various sensors to the planter row unit controller 64 are schematically indicated in FIG. 8A by lines connecting the sensors to the controller with an arrowhead indicating the flow of the signal from the sensor to the planter row unit controller 64.

Similarly, the planter row unit controller 64 will generate control signals for controlling the operation of the various actuators such as down pressure actuator 92 and the seed delivery mechanism 32.

Planter row unit controller 64 includes or may be associated with a processor 78, a computer readable medium 80, a data base 82 and an input/output module or control panel 84 having a display 86. An input/output device 88, such as a keyboard, joystick or other user interface, is provided so that the human operator may input instructions to the controller. It is understood that the planter row unit controller 64 described herein may be a single controller having all of the described functionality, or it may include multiple controllers wherein the described functionality is distributed among the multiple controllers.

Various operations, steps or algorithms as described in connection with the planter row unit controller 64 can be embodied directly in hardware, in a computer program product 90 such as a software module executed by the processor 78, or in a combination of the two. The computer program product 90 can reside in RAM memory, flash memory, ROM memory, EPROM memory, EEPROM memory, registers, hard disk, a removable disk, or any other form of computer-readable medium 80 known in the art. An exemplary computer-readable medium 80 can be coupled to the processor 78 such that the processor can read information from, and write information to, the memory/ storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The control panel 84 may for example be physically located on the planter row unit 10 such that the control panel 84 is supported directly or indirectly from the frame 14. Optionally, or additionally, the control panel 84 or some portion thereof may be remotely located, such as on the tractor 15 or on a handheld device carried by a human operator. Further, in the event of an autonomous tractor 15 the control panel 84 or some portion thereof may be located at a remote-control station and may be communicated with the planter row unit controller 64 wirelessly.

### Planter Row Unit Controllers Plus Master Controller:

As schematically shown in FIG. 8B, in addition to the individual planter row unit controllers 64.1, 64.2, 64.3 etc. associated with the planter row units 10.1, 10.2, 10.3, etc., the agricultural implement may include a master controller 94 configured to receive the vibration profiles of the individual planter row units 10 and to compare the vibration profiles of the individual planter row units to identify one of the planter row units having an abnormal vibration profile. The details of construction of the master controller 94 may be substantially the same as described above for the planter row unit controller 64.

As schematically illustrated in FIG. 4 the master controller 94 may be located on operator’s platform of the tractor 15. The master controller 94 may be communicated by wire or wirelessly with the planter row unit controllers 64 so that the master controller 94 may receive and compare the data from the individual planter row unit controllers 64. This allows the vibration profiles from each of the planter row units 10 to be compared to create a baseline profile for a given field and to help identify when a specific planter row unit 10 has wear or damage.

### Central Control Unit With Individual Vibration Sensors

As schematically shown in FIG. 8C, another suitable architecture for the monitoring system disclosed herein is to provide each of the planter row units with a vibration sensor 66 mounted directly or indirectly on the frame 14 and to communicate all of the vibration sensors 66 directly with a central controller 94, which again may be located on the tractor 15. In this embodiment it is not necessary for each planter row unit 10 to have an individual controller 64, although they may have such an individual controller.

In this embodiment the central controller 94 serves as the controller for the vibration analysis for each of the planter row units 10, and also serves to compare the data of the individual planter row units 10 to each other.

### Vibration Profile Analysis

Regardless of which of the controller system architectures is selected, there are multiple vibration profile analyses which may be conducted by the controller or controllers 64 and/or 94 associated with the vibration sensors 66. In general the controller may be configured to receive signals from the vibration sensor 66 of the planter row unit 10 and to monitor a vibration profile of the planter row unit 10 over time.

The controller 64 and/or 94 may be programmed to identify a normal vibration profile for a properly functioning planter row unit 10. Such identification may be programmed via the computer software product 90. Or the controller 94 having access to the current vibration profiles for multiple planter row units 10 on a common planter 11 may compare those profiles and determine a current normal profile. The controller 64 and/or 94 may then identify one or more abnormal vibration profiles detected for one of the planter row units 10. Such an abnormal vibration profile may be identified generally, without identification of the specific cause of the abnormality, or it may be identified specifically. Specific identification of the cause of the abnormal vibration profile may be done by providing the controller with a description of known abnormal vibration profiles associated with a given malfunction of the planter row unit.

For example, when using the cutting wheel disc 24 as shown in FIGS. 5A and 5B including the wear indicators 74, historical data may be used to identify the characteristics of the vibration profile of a worn cutting wheel disc as seen in FIG. 5B having the ground engaging surface 68 including a periphery 70 interrupted by the holes 74. Such a ground engaging surface 68 will cause a recognizable vibration profile of increased intensity which can be identified by the controller 64 and/or 94 to identify the abnormal vibration profile as being caused by a worn cutting wheel disc 24.

Similarly, other repeatable malfunctions, such as for example a failed wheel bearing or press fit on one of the wheels of the planter row unit 10, or a planter row unit 10 plugged by mud so that its components have ceased to rotate, may create other identifiable abnormal vibration profiles.

Other abnormal vibration profiles, such as for example a bent wheel or other component due to striking a rock, may only be identifiable generally, without identification by the controller of the specific cause.

The controller 64 and/or 94 may take various actions in response to detection of an abnormal vibration profile. In the case of a manned agricultural machine having a human operator located on the tractor 15, the controller may simply provide a warning indication to the human operator in audible and/or visual format.

In the case of an autonomously operated tractor 15, wherein there is no human operator on the tractor, the controller 94 may be located at a location far removed from the field where the tractor and the planter 11 are operating. In such a situation, depending on the nature of the abnormal vibration profile identified, the controller may provide the notifications or warnings to the remote operator of the existence of the abnormal condition and the controller may direct further automatic actions of the tractor.

For example, if the controller specifically identifies an abnormal vibration profile corresponding to a plugged planter row unit 10 or a damaged planter row unit 10 that is incapable of properly performing the planting operation, the controller may direct the tractor 15 to stop operation so as to avoid wasting resources on a defective planting operation.

FIGS. 7A-7F show example vibration profiles for the disc 24 shown in FIGS. 6A-6C, having a wear indicator 74 including a pattern of twelve equally spaced holes 74.1-74.12 spaced radially inward by spacing 75 from the outer circumference 70 of the disc 24 in its unworn state as shown in FIG. 6A. FIG. 6B shows the disc 24 in a partially worn state wherein the outer circumference 70 has worn down until it is just starting to merge with the holes 74. FIG. 6C shows the disc 24 in a completely worn state in which the disc 24 has worn down to the mid-points of the holes 74 thus creating a periphery expected to generate a maximum magnitude of vibration. It will be understood that other wear states could be defined as a maximum acceptable wear state depending on the design of the disc 24 and its associated wear indicator 74.

It is further noted that the example vibration profiles shown in FIGS. 7A-7F were created based upon a prediction of the relative magnitudes of vibration to be experienced by the disc 24 for the various abnormalities discussed below. The FIGS. 7A-7F do not represent actual experimental data.

In FIGS. 7A-7F the horizontal axis represents degrees of rotation of the disc 24, and one complete rotation of 360 degrees is shown. The vertical axis represents a relative magnitude of detected vibration.

FIG. 7A shows a vibrational level of normal operation representative of an unworn disc experiencing no abnormal vibration generating conditions. Such an unworn disc 24 is schematically represented in FIG. 6A. The vibration illustrated in FIG. 7A may be considered a baseline vibration to be expected for given row unit and field conditions.

FIG. 7B shows an expected vibration profile for a partially worn disc 24 such as shown in FIG. 6B wherein the wear of the outer circumference 70 has just started to merge with the holes 74. Note that superimposed on vibration similar to that of FIG. 7A there is a periodic spike at each thirty degrees of rotation representing the engagement of each partially opened hole 74 with the ground 19.

FIG. 7C shows an expected vibration profile for a completely worn disc 24 such as shown in FIG. 6C wherein the wear of the outer circumference 70 has progressed all the way to the midpoint of each hole 74. Note that again there is a periodic spike at each thirty degrees of rotation, but the spikes are of greater magnitude than those seen in FIG. 7B.

FIG. 7D shows a straight line non-varying vibrational level representative of a plugged planter row unit 10 wherein the various rotating components are plugged with mud and have ceased to rotate. Thus, a ball of mud is basically dragging across the ground.

FIG. 7E shows an expected vibration profile for a bent guage wheel or other bent component. FIG. 7E could apply to any bent component, including the cutting wheel discs 24, the closing wheels 28, the gauge wheels 30, and the furrow shaper 28. Note there may be a single large spike in vibration during each rotation of the disc. That spike is superimposed on background vibration similar to that of FIG. 7A.

FIG. 7F shows an expected vibration profile representative of a bearing failure on one of the wheels. FIG. 7F could apply to bearing failure on any wheel, including the cutting wheel discs 24, the closing wheels 28 and the gauge wheels 30. Note that the shape of the vibration is similar to that of the background vibration of FIG. 7A, but the magnitude of the vibration is increased due to the looseness of the wheel mounting.

Thus, it is seen that the apparatus and methods of the embodiments disclosed herein readily achieve the ends and advantages mentioned as well as those inherent therein. While certain preferred embodiments have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. A planter row unit, comprising:
a frame;
a cutting wheel disc supported directly or indirectly from the frame for cutting a furrow in a ground surface;
a seed delivery mechanism supported directly or indirectly from the frame to deposit seeds into the furrow;
a vibration sensor supported directly or indirectly from the frame; and
a controller configured to receive signals from the vibration sensor and to monitor a vibration profile of the planter row unit over time.

2. The planter row unit of claim 1, wherein:
the controller is a planter row unit controller configured to control operation of the seed delivery mechanism; and
the vibration sensor is mounted on a circuit board of the planter row unit controller.

3. The planter row unit of claim 1, wherein:
the cutting wheel disc includes a ground engagement surface configured to engage the ground surface to cut the furrow; and
the cutting wheel disc further includes a wear indicator configured to change a shape of the ground engagement surface as the cutting wheel disc wears.

4. The planter row unit of claim 3, wherein:
the wear indicator includes one or more holes formed in the cutting wheel disc and arranged such that as the ground engagement surface wears the ground engagement surface merges with the one or more holes thereby creating an interruption in the ground engagement surface.

5. The planter row unit of claim 4, wherein:
the ground engagement surface includes a circumferential periphery of the cutting wheel disc, and the one or more holes includes a plurality of holes initially formed in an unworn cutting wheel disc as a pattern of holes radially spaced inward from the circumferential periphery.

6. The planter row unit of claim 5, wherein:
the pattern of holes is a circular pattern concentric with the circumferential periphery.

7. The planter row unit of claim 3, wherein:
the controller is configured to detect a change in the vibration profile of the planter row unit corresponding to the change in shape of the ground engaging surface.

8. The planter row unit of claim 3, wherein:
the controller is configured to identify a vibration profile associated with a worn cutting wheel disc for which the shape of the ground engaging surface has been changed by the wear indicator; and
the controller is further configured to provide a warning indication to an operator of the planter row unit informing the operator of the existence of the worn cutting wheel disc.

9. The planter row unit of claim 3, wherein:
the controller is configured to identify one or more abnormal vibration profiles.

10. The planter row unit of claim 9, wherein:
the controller is further configured to provide a warning indication to an operator of the planter row unit informing the operator of the existence of the abnormal vibration profile.

11. The planter row unit of claim 9, wherein:
the one or more abnormal vibration profiles includes a vibration profile corresponding to a bent ground engaging component of the planter row unit.

12. The planter row unit of claim 9, wherein:
the one or more abnormal vibration profiles includes a vibration profile corresponding to worn bearing of a ground engaging wheel of the planter row unit.

13. The planter row unit of claim 9, wherein:
the one or more abnormal vibration profiles includes a vibration profile corresponding to a plugged planter row unit.

14. The planter including the planter row unit of claim 1, and further comprising:
one or more additional planter row units, each planter row unit including its own planter row unit controller and associated vibration sensor; and
a master controller configured to receive the vibration profiles of the individual planter row units and to compare the vibration profiles of the individual planter row units to identify one of the planter row units having an abnormal vibration profile.

15. An agricultural implement, comprising:
a frame; and
a disc supported from the frame for cutting a furrow in a ground surface, the disc including a ground engagement surface configured to engage the ground surface to cut the furrow and a wear indicator configured to change a shape of the ground engagement surface as the disc wears.

16. The agricultural implement of claim 15, further comprising:
a vibration sensor supported directly or indirectly from the frame; and
a controller configured to receive signals from the vibration sensor and to monitor a vibration profile of the disc.

17. The agricultural implement of claim 15, wherein:
the wear indicator includes one or more holes formed in the disc and arranged such that as the ground engagement surface wears the ground engagement surface merges with the one or more holes thereby creating an interruption in the ground engagement surface.

18. The agricultural implement of claim 17, wherein:
the ground engagement surface includes a circumferential periphery of the disc, and the one or more holes includes a plurality of holes initially formed in an unworn disc as a pattern of holes radially spaced inward from the circumferential periphery.

19. The agricultural implement of claim 18, wherein:
the pattern of holes is a circular pattern concentric with the circumferential periphery.

20. The agricultural implement of claim 18, wherein:
the pattern of holes is spaced radially inward a distance in a range of from 0.25 inch to 3.0 inch from the circumferential periphery to a radially outermost part of the holes in the unworn disc.
